(19) United States
(12) Patent Application Publication
(10) Pub. No.: US 2018/0120236 A1
(43) Pub. Date: May 3, 2018

(54) NATURAL JEWELRY AUTHENTICITY IDENTIFICATION METHOD AND SYSTEM BASED ON MICROSCOPIC THREE-DIMENSIONAL IMAGING TECHNIQUE

(71) Applicant: SHENZHEN UNIVERSITY, Shenzhen (CN)

(72) Inventors: Shaoping Lu, Shenzhen (CN); Chen Xu, Shenzhen (CN); Zhenyu Di, Shenzhen (CN); Feipeng Li, Shenzhen (CN)

(21) Appl. No.: 15/856,041

(22) Filed: Dec. 27, 2017

Related U.S. Application Data
(63) Continuation of application No. PCT/CN2015/085583, filed on Jul. 30, 2015.

(51) Int. Cl. G01N 21/87; G06T 19/00; G06T 7/00

(52) U.S. Cl. CPC G01N 21/87; G06T 19/006; G06T 2207/10012; G06T 7/001; G06T 2207/10056; H04N 13/0239

(57) ABSTRACT

A natural jewelry authenticity identification method comprises: scanning the whole appearance of each jewel by three-dimensional microscopic scanning and completely recording appearance characteristics of the jewel; a three-dimensional imaging technique is used to generate a three-dimensional entity image of the jewel, and a digest algorithm is used to compress three-dimensional entity image information about the jewel into a unique digest code, wherein the three-dimensional entity image and the digest code are published as publishable archive information; and if a receiver is a dealer, the same method is adopted to generate a digest code of the natural jewel, and the digest code is compared with the published digest code; and if the receiver is an individual buyer, after the natural jewel is received, the actual object is magnified and compared with the published three-dimensional entity image, and if the comparison is matched, the natural jewel is identified as authentic.

### CROSS-REFERENCE TO RELATED APPLICATIONS

This application is a Continuation application of PCT Application No. PCT/CN2015/085583, filed on Jul. 30, 2015, the entire contents of which are hereby incorporated by reference.

### TECHNICAL FIELD

The present invention relates to the technical field of jewelry identification, and more particularly to a method and a system for natural jewelry authenticity identification which are based on a microscopic three-dimensional imaging technique.

### BACKGROUND

The rapid development of the Internet results in a variety of e-commerce transaction platforms. With continual improvements of people's living standards, transactions in the jewelry market are active and the jewelry market is rapidly developed. According to statistics, from 2005 to 2013, the sales volume of the jewelry market had increased by about 3.5 times, the total volume of retail sales of jewelry products in China had exceeded 470 billions yuan in 2013. However, the volume of online retail sales of the jewelry products only accounted for about 3.5% of the industry's total sales in China, which is extremely lower than a proportion of the online retail sales in the international market which accounts for about 30%. The reasons may be the lack of credibility such as shoddy and fake as well as the differences in understanding and the lack of an identification means.

One of the traditional identification means depends on the experience of a buyer; however, in an online transaction process, it is difficult to achieve an accurate judgment only based on the pictures provided by sellers even for the experienced buyer. The reasons are, on the one hand, the presented subject could be much different from the actual object in natural light due to the different capturing angles, background lights and the like, and on the other hand, the picture provided online may be inauthentic since a merchant may cover up flaws to make the commodity look as beautiful as possible. A second traditional identification means depends on a jewel identification certificate provided by the merchant; however, some merchants have behaviors such as fakes or using one certificate for multiple commodities, such that even if the certificate is authentic, whether the jewel is authentic or cannot be confirmed. In addition, for the merchant purchasing the jewels in bulk, it is fallible and inefficient to identify the jewels one by one.

Therefore, the present invention aims at providing a proper identification means to solve the problems of identifying the authenticity of a natural jewel for a buyer in the e-commerce field.

### SUMMARY

### Technical Problem

A technical problem to be solved by the present invention aims at providing a method and a system for natural jewelry authenticity identification, which are based on a microscopic three-dimensional imaging technique to solve the problem of identifying the authenticity of a natural jewel for a receiver in the e-commerce field.

### Technical Solution

The present invention provides a natural jewelry authenticity identification method based on a microscopic three-dimensional imaging technique, which includes a uniqueness archive information generation means, an automatic comparison identification means and a manual comparison identification means of a natural jewel.

The uniqueness archive information generation method of the natural jewel according to the present invention includes the following steps:

scanning the natural jewel to obtain its appearance characteristic data, generating a three-dimensional entity image according to the obtained appearance characteristic data, and generating digest code according to the information about the three-dimensional entity image, wherein the three-dimensional entity image and the digest code are published as publishable archive information about the natural jewel.

The automatic comparison identification method of the natural jewel according to the present invention specifically includes the following steps:

step A: scanning the natural jewel to be identified to obtain its appearance characteristic data, generating a three-dimensional entity image according to the obtained appearance characteristic data, and further generating a digest code according to the information about the three-dimensional entity image; and
step B: comparing the generated digest code with a digest code in archive information about the natural jewel to be identified published by a shipper, wherein when the comparison is matched, the natural jewel is identified as authentic.

Preferably, the three-dimensional entity image of the natural jewel is generated by a digital image stitching technique according to the appearance characteristic data obtained by the three-dimensional microscopic scanning method.

Preferably, the step B includes the following step:

restoring the three-dimensional entity image of the natural jewel to be identified by utilizing VRML (Virtual Reality Modeling Language) so as to be reproduced on a computer screen.

Preferably, the digest code is formed by compressing the information about the three-dimensional entity image by using a digest algorithm.

Preferably, the three-dimensional microscopic scanning method specifically includes the following steps:

step 1, placing the natural jewel to be identified in a central area of a rotary disk, which can rotate 360 degrees about its rotary shaft;
step 2, placing two microscopic cameras on vertical rotary stands, adjusting their starting positions on the vertical rotary stands to enable the two microscopic cameras to capture the topmost end of the natural jewel to be identified, and adjusting an imaging included angle between the two microscopic cameras and the natural jewel to be identified by rotating the two vertical rotary stands according to a dimension of the natural jewel to be identified;
step 3, rotating the rotary disk 360 degrees about its rotary shaft at a constant speed, obtaining an appearance characteristic data including a detail characteristics of the natural jewel to be identified by the two microscopic cameras;
step 4, sliding the two microscopic cameras downwards for a certain position; and
step 5, repeating the steps 3 and 4 alternatively, until all of the appearance characteristic data, including specific region signatures, of the natural jewel to be identified are obtained.

The manual comparison identification method of the natural jewel according to the present invention specifically includes the following steps:

step a: scanning a natural jewel to be identified to obtain its appearance characteristic data, generating a three-dimensional entity image according to the obtained appearance characteristic data, and publishing the three-dimensional entity image; and
step b: after a receiver receives the natural jewel to be identified, a characteristic region of the natural jewel to be identified being magnified and compared with a corresponding region of the three-dimensional entity image published by a shipper; wherein when the comparison is matched, the natural jewel is identified as authentic.

The present invention further provides a natural jewelry authenticity identification system based on a microscopic three-dimensional imaging technique, including a uniqueness archive information generation means, an automatic comparison identification means or a manual comparison identification means of a natural jewel.

The uniqueness archive information generation system of the natural jewel according to the present invention includes:

a scanning apparatus configured to scan the natural jewel to obtain an appearance characteristic data thereof;

an image generation module configured to generate a three-dimensional entity image according to the obtained the appearance characteristic data; and

an encoding module configured to generate a digest code according to information about the three-dimensional entity image.

The automatic comparison identification system of the natural jewel according to the present invention includes:

a scanning apparatus configured to scan the natural jewel to be identified to obtain an appearance characteristic data thereof;

an image generation module configured to generate a three-dimensional entity image according to the obtained the appearance characteristic data;

an encoding module configured to generate a digest code according to information about the three-dimensional entity image; and

a comparison module configured to compare the generated digest code with a digest code, which is published by a shipper, in archive information about the natural jewel to be identified; and if the comparison is matched, the natural jewel is identified as authentic.

Preferably, the three-dimensional entity image of the natural jewel is generated by a digital image stitching technique according to the appearance characteristic data obtained by a three-dimensional microscopic scanning method.

The three-dimensional entity image of the natural jewel is restored by utilizing a virtual reality modeling language so as to be reproduced on a computer screen.

The digest code is formed by compressing the information about the three-dimensional entity image by using a digest algorithm.

Preferably, the three-dimensional microscopic scanning means specifically includes the following steps:

step 1, placing a natural jewel to be identified in a central area of a rotary disk, which can rotate 360 degrees about its rotary shaft;
step 2, placing two microscopic cameras on the vertical rotary stands, adjusting the initial positions of the cameras on the vertical rotary stands to capture a topmost end of the natural jewel to be identified, and adjusting an imaging included angle between the two microscopic cameras and the natural jewel to be identified by rotating the two vertical rotary stands according to a dimension of the natural jewel to be identified;
step 3, rotating the rotary disk 360 degrees about its rotary shaft at a constant speed, obtaining appearance characteristic data including detail characteristics of the natural jewel to be identified by the two microscopic cameras;
step 4, sliding the two microscopic cameras downwards for a certain position; and
step 5, repeating the steps 3 and 4 alternatively, until all of the appearance characteristic data, including specific region signatures, of the natural jewel to be identified, are obtained.

The manual comparison identification system of the natural jewel according to the present invention specifically includes:

a scanning apparatus, which is configured to scan the natural jewel to be identified to obtain appearance characteristic data thereof,

an image generation module configured to generate a three-dimensional entity image according to the obtained appearance characteristic data, and publish the three-dimensional entity image,

wherein after a receiver receives the natural jewel to be identified, a characteristic region of the natural jewel to be identified is magnified and compared with a corresponding region of the three-dimensional entity image; and when the comparison is matched, the natural jewel is identified as authentic.

### Advantageous Effects

The present invention provides a method and system of a natural jewel authenticity identification method which are based on a microscopic three-dimensional imaging technique. The method and the system solve a problem of identifying the authenticity of a natural jewel for a receiver in the e-commerce field; and the identification method is automatic, efficient and inexpensive, simple and easy to implement, and improves the identification efficiency.

### BRIEF DESCRIPTION OF THE DRAWINGS

FIG. 1 is a flow diagram of an automatic comparison identification means of a natural jewel according to an embodiment of the present invention;

FIG. 2 is a front view of a three-dimensional microscopic scanner according to an embodiment of the present invention;

FIG. 3 is a top view of a three-dimensional microscopic scanner according to an embodiment of the present invention;

FIG. 4 is a flow diagram of a scanning means of a three-dimensional microscopic scanner according to an embodiment of the present invention;

FIG. 5 is a schematic diagram of a uniqueness archive information generation system of a natural jewel according to an embodiment of the present invention;

FIG. 6 is a flow diagram of a manual comparison identification means of a natural jewel according to an embodiment of the present invention;

FIG. 7 is a schematic diagram of an automatic comparison identification system of a natural jewel according to an embodiment of the present invention;

FIG. 8 is a schematic diagram of an automatic identification process of a natural jewel for a dealer according to an embodiment of the present invention; and

FIG. 9 is a schematic diagram of a manual identification process of a natural jewel for an individual buyer according to an embodiment of the present invention.

### DESCRIPTION OF THE EMBODIMENTS

In order to make the objective, the technical solution and the advantages of the present invention be more apparent, the present invention will be described further in detail with reference to accompanying drawings and embodiments. It should be understood that specific embodiments described herein are merely illustrative of the present invention and are not intended to limit the present invention.

The concept of the present invention is as follows: a shipper scans a three-dimensional entity image of each natural jewel by means of three-dimensional microscopic scanning and a three-dimensional imaging technique. Further a digest code of each natural jewel is generated by means of a digest encoding technique. The three-dimensional entity image and the digest code is published as publishable archive information on an e-commerce platform. A receiver may obtain a digest code of each natural jewel after receiving the natural jewel by adopting the above described method, and then compares the generated digest code with a digest code published by a shipper. If the comparison is matched, the natural jewel is identified as authentic. Alternatively, after the natural jewel is received, the natural jewel is magnified and compared with the three-dimensional entity image published on the e-commerce platform, and if the comparison is matched, the natural jewel is identified as authentic.

A natural jewel authenticity identification method based on a microscopic three-dimensional imaging technique is firstly introduced hereinafter. The method includes a uniqueness archive information generation means, an automatic comparison identification means or a manual comparison identification means of a natural jewel.

The uniqueness archive information generation method of the natural jewel particularly includes the following steps:

scanning the natural jewel to obtain its appearance characteristic data, generating a three-dimensional entity image according to the obtained appearance characteristic data, and generating a digest code according to the information about the three-dimensional entity image, wherein the three-dimensional entity image and the digest code serve as publishable archive information of the natural jewel.

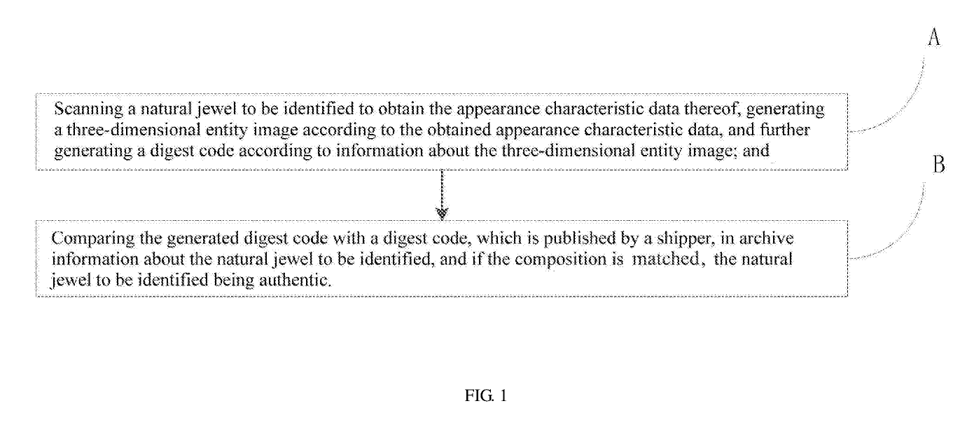

The automatic comparison identification method of the natural jewel is particularly introduced hereinafter, as shown in FIG. 1, the automatic comparison identification means includes the following steps:

step A: scanning the natural jewel to be identified to obtain its appearance characteristic data, generating a three-dimensional entity image according to the obtained appearance characteristic data, and further generating a digest code according to the information about the three-dimensional entity image; and
step B: comparing the generated digest code with a digest code, which is published by a shipper, in archive information about the natural jewel to be identified; and if the comparison is matched, the natural jewel is identified as authentic.

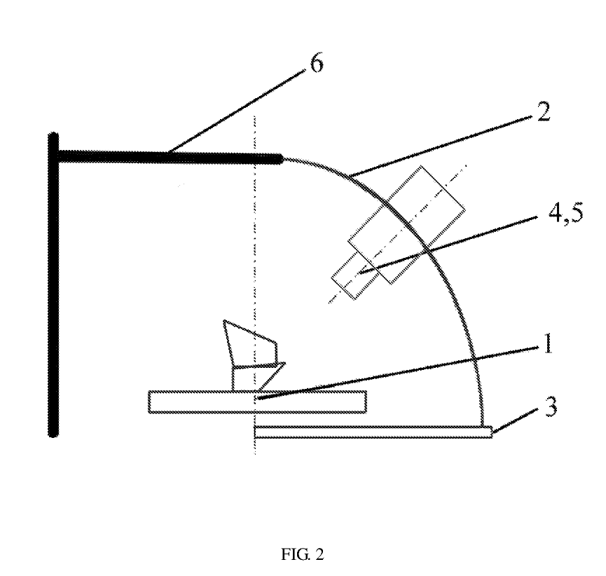

A scanning apparatus adopted in a specific embodiment of the present invention is a three-dimensional microscopic scanner, a front view of which is shown in FIG. 2.

The scanner includes a rotary disk 1 for placing an object to be scanned, two arc-shaped vertical rotary stands 2, an arc-shaped horizontal rotary stand 3, a first microscopic camera 4, a second microscopic camera 5 and a fixed frame 6;

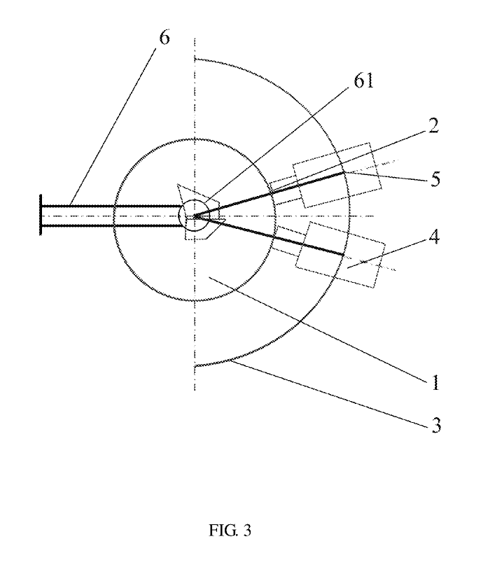

The rotary disk 1 is horizontally placed and capable of rotating 360 degrees about its rotary shaft at a constant speed. The horizontal rotary stand 3 is horizontally placed, with its center located on the axis of the rotary shaft of the rotary disk 1. The fixed frame 6 is located above the rotary disk 1. The two arc-shaped vertical rotary stands 2, which are mounted between the fixed frame 6 and the horizontal rotary stand 3, can rotate about the rotary shaft of the rotary disk 1. The top view of the scanner is shown in FIG. 3, a circular ring 61 is provided on the fixed frame 6, and the center of the circular ring 61 is located on the axis of the rotary shaft of the rotary disk 1. The top ends of the vertical rotary stands 2 can slide about the circular ring 61 on the fixed frame. The bottom ends of the vertical rotary stands 2 can slide about the center of the rotary disk 1 on the surface of the horizontal rotary stand 3.

The first microscopic camera 4 and the second microscopic camera 5 are respectively placed on the vertical rotary stands 2, and each connected with a corresponding vertical rotary stand 2 by a sliding block, so as to be slidable around the center of the rotary disk 1 along the vertical rotary stand 2.

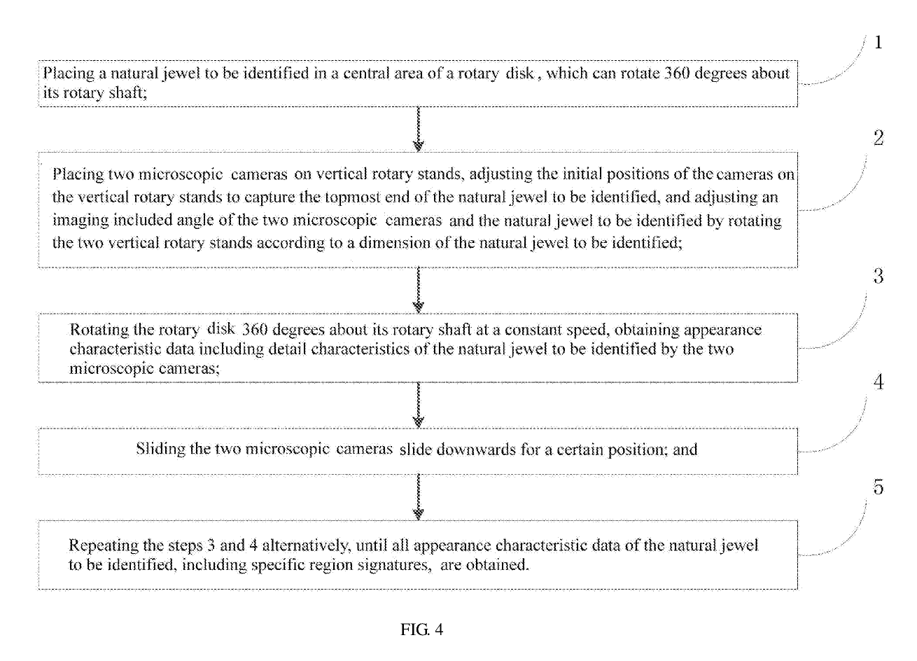

As illustrated in the embodiment of the present invention, the microscopic cameras are high-magnification cameras and the object to be scanned is a natural jewel. As shown in FIG. 4, the scanning means of the three-dimensional microscopic scanner includes the following steps:

step 1, placing a natural jewel to be identified in a central area of the rotary disk which can rotate 360 degrees about its rotary shaft;
step 2, placing two high-magnification cameras on the vertical rotary stands, adjusting the initial positions of the cameras on the vertical rotary stands to capture the topmost end of the natural jewel to be identified, and adjusting an imaging included angle between the two high-magnification cameras and the natural jewel to be identified by rotating the two vertical rotary stands, according to a dimension of the natural jewel to be identified;
step 3, rotating the rotary disk by 360 degrees about its rotary shaft at a constant speed, and obtaining appearance characteristic data, including detail characteristics, of the natural jewel to be identified by the two high-magnification cameras;
step 4, sliding the two high-magnification cameras downwards for a certain position; and
step 5, repeating the steps 3 and 4 alternatively, until all appearance characteristic data of the natural jewel to be identified, including specific region signatures, are obtained.

For a natural jewel without a bracket, when the two high-magnification cameras slide to horizontal positions relative to the natural jewel, that is, when appearance characteristic data of the upper portion of the natural jewel is obtained, the natural jewel will be manually turned over to capture the lower portion of the natural jewel. The specific operation steps include: sliding the two high-magnification cameras to an initial placement positions, and then repeating the steps 3 and 4 alternatively, until the appearance characteristic data of the lower portion of the natural jewel is obtained.

An imaging process of the three-dimensional entity image is a process of composing a complete three-dimensional entity image from the appearance characteristic data obtained by the three-dimensional microscopic scanner by using the related algorithm and a digital image stitching technique, and actually restoring it by utilizing a VRML (Virtual Reality Modeling Language) so as to be reproduced on a computer screen, such that the three-dimensional entity image of the natural jewel may be freely rotated, zoomed in or out under the control of a mouse. As a result, the overall effect can be enjoyed from different angles, and local details may be observed from any angle.

The digest code is formed by compressing information about the three-dimensional entity image by using a digest algorithm. Since the digest algorithm has the properties of consistency and irreversibility, the obtained encoded information for each jewel is unique encoded information.

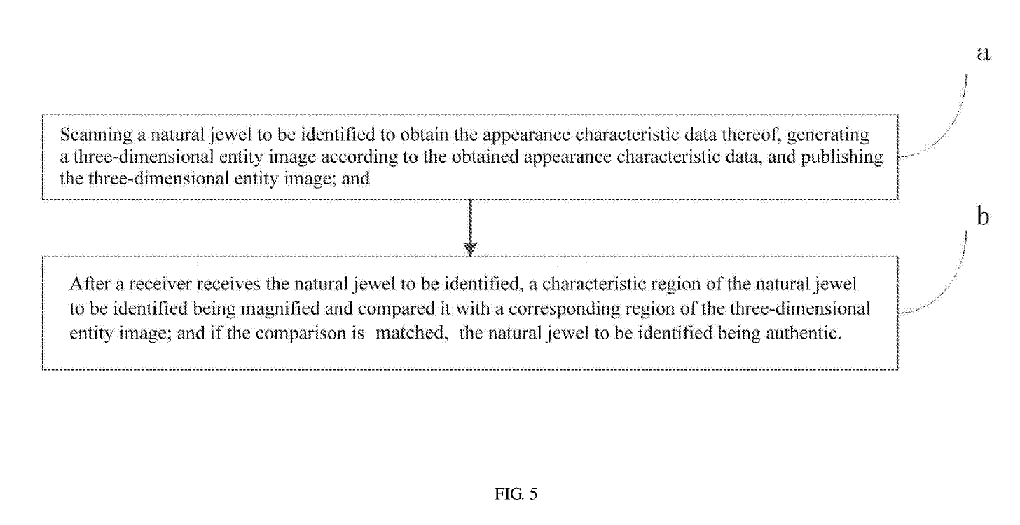

As shown in FIG. 5, the natural jewel identification method according to another embodiment of the present invention includes the following steps:

step a: scanning a natural jewel to be identified to obtain its appearance characteristic data, generating a three-dimensional entity image according to the obtained appearance characteristic data, and publishing the three-dimensional entity image; and
step b: after a receiver receives the natural jewel to be identified, the natural jewel being magnified and compared with the three-dimensional entity image; and if the comparison is matched, the natural jewel is identified as authentic.

In fact, each natural jewel is unique, and has signatures such as flaws; and by comparing the magnified actual object with the three-dimensional entity image, whether the actual object received by the receiver is consistent with an object purchased online or not may be determined, and in turn whether the natural jewel to be identified is authentic or not may be determined.

A natural jewel authenticity identification system based on a microscopic three-dimensional imaging technique will be introduced hereinafter. The system includes a uniqueness archive information generation means, an automatic comparison identification means and a manual comparison identification means of a natural jewel.

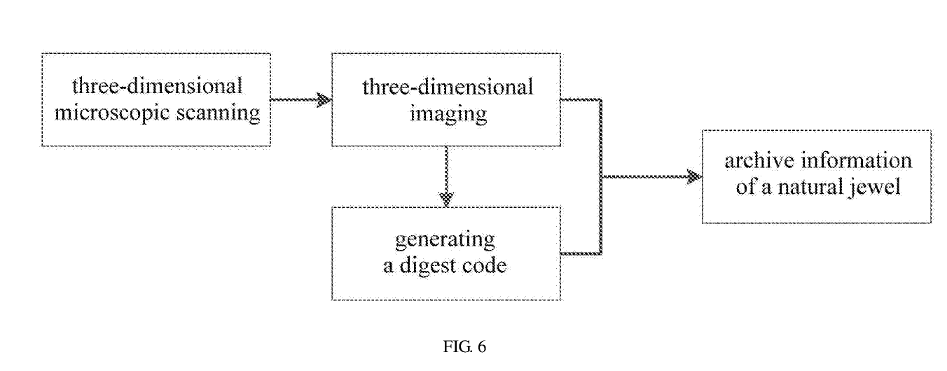

As shown in FIG. 6, the uniqueness archive information generation system of the natural jewel according to the present invention includes:

a scanning apparatus, which is configured to scan the natural jewel to obtain an appearance characteristic data thereof;

an image generation module, which is configured to generate a three-dimensional entity image according to the obtained appearance feature data; and

an encoding module, which is configured to generate a digest code according to information about the three-dimensional entity image.

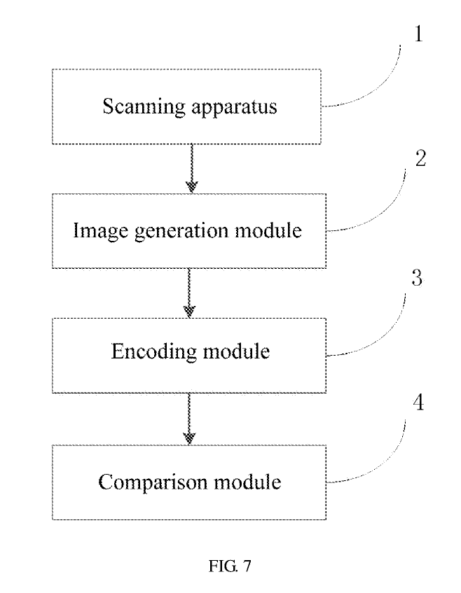

As shown in FIG. 7, An automatic comparison identification system of natural jewels according to an embodiment of the present invention includes:

a scanning apparatus 1, which is configured to scan a natural jewel to be identified to obtain the appearance characteristic data thereof;

an image generation module 2, which is configured to generate a three-dimensional entity image according to the obtained appearance characteristic data;

an encoding module 3, which is configured to generate a digest code according to information about the three-dimensional entity image; and

a comparison module 4, which is configured to compare the generated digest code with a digest code, which is published by a shipper, in archive information about the natural jewel to be identified; and if the comparison is matched, the natural jewel is identified as authentic.

An manual comparison identification system of the natural jewel according to an embodiment of the present invention includes:

a scanning apparatus, which is configured to scan the natural jewel to be identified to obtain appearance characteristic data thereof,

an image generation module, which is configured to generate a three-dimensional entity image according to the obtained appearance characteristic data, and publish the three-dimensional entity image; and

after a receiver receives the natural jewel to be identified, a flawed area or other characteristic regions of the natural jewel is magnified with a magnifying glass or by a camera of a mobile phone and compared with a corresponding region of the three-dimensional entity image. If the comparison is matched, the natural jewel is identified as authentic.

Hereinafter, such an identification process will be introduced by way of specific examples, in which a seller refers to a shipper and a buyer refers to a receiver.

### Example 1

When an online jewel retailer sells a jade pendant, all appearance details of the jade pendant are recorded by a three-dimensional microscopic scanner, including some natural flaws or signatures that are distributed on the surface; and a three-dimensional entity jade pendant including the natural flaws or signatures is generated by a digital technique and a three-dimensional imaging technique. Further, a unique digest code of the jade pendant is generated by a digest algorithm. The three-dimensional entity image and the digest code of the jade pendant are correlated as archive information of the jewel and published on an e-commerce platform.

The buyer can appreciate the jade pendant through the three-dimensional entity image published on the e-commerce platform, and consider whether to buy it or not. In addition, the buyer can identify the authenticity of the jade pendant after buying it. An identification process after the buyer gets the jade pendant will be introduced below by way of two specific examples.

### Example 2

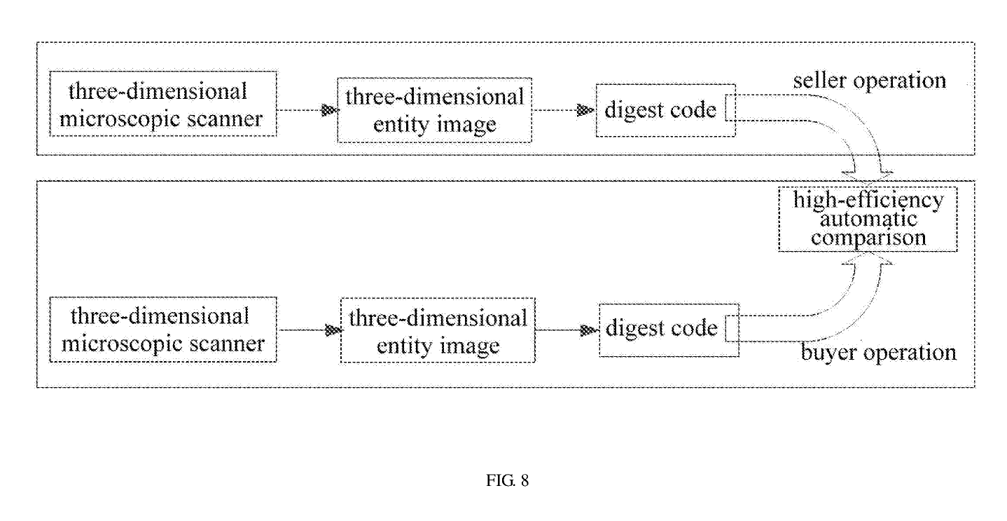

As for a dealer, the dealer can utilize an appearance of the jewel having a property of very low repeatability, like fingerprints. After purchasing the jade pendants in bulk, the dealer obtains the appearance characteristic data of the jade pendants by a three-dimensional microscopic scanner and composes a complete three-dimensional entity image by using the related algorithm and a digital image stitching technique according to the appearance characteristic data. Then a digest code is generated by utilizing a digest encoding technique. By comparing the automatically the generated uniqueness digest code with the uniqueness code published by the seller, whether the jade pendant to be identified is the one chosen and purchased by the buyer or not may be identified. The identification process is shown in FIG. 8. Compared with a manual identification, this method greatly increases the identification efficiency and reduces the risk of mistakes and omissions caused by the manual identification. The identification method is automatic, efficient and inexpensive.

### Example 3

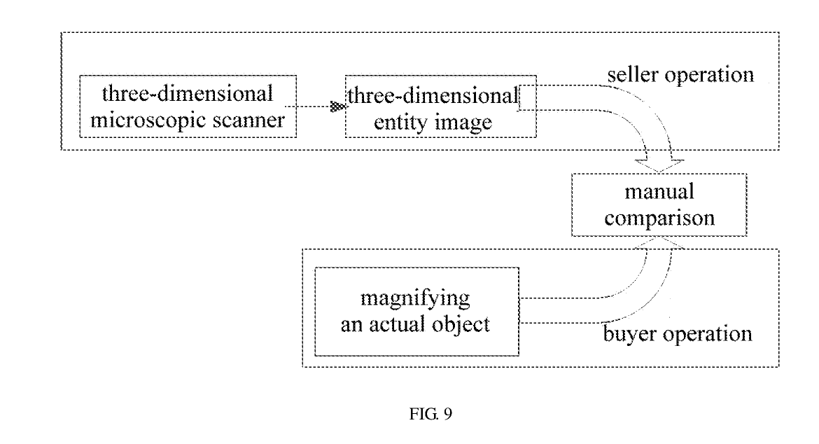

As for an individual buyer, the individual buyer can utilize an appearance of a natural jewel having a property of very low repeatability, like fingerprints. After receiving the purchased jade pendant, the individual buyer identifies whether the received jade pendant is the one chosen and purchased by the buyer or not by comparing the received jade pendant which is magnified by a camera or a magnifying glass with the jade pendant in the three-dimensional entity image published by the seller. The identification process is shown in FIG. 9. Such an identification process is simple and easy to operate.

The present invention provides a method and system of a natural jewel authenticity identification which are based on a microscopic three-dimensional imaging technique. The method and the system solve a problem of identifying the authenticity of a natural jewel in the e-commerce field; and the identification method is automatic, efficient and inexpensive, simple and easy to implement, and greatly increases the identification efficiency.

The foregoing is merely illustrative of preferred embodiments of the present invention which is not intended to limit the present invention. Any modifications, equivalent substitutions and improvements made within the spirit and principles of the present invention are intended to be encompassed within a protective scope of the present invention.

What is claimed is:

1. A natural jewelry authenticity identification method based on a microscopic three-dimensional imaging technique, comprising:
a uniqueness archive information generation means of a natural jewel, and
an automatic comparison identification means or a manual comparison identification means.

2. The natural jewelry authenticity identification method according to claim 1, wherein the uniqueness archive information generation means of a natural jewel comprises the following steps:
scanning a natural jewel to obtain its appearance characteristic data;
generating a three-dimensional entity image according to the obtained appearance characteristic data; and
generating a digest code according to information about the three-dimensional entity image,
wherein the three-dimensional entity image and the digest code are published as publishable archive information about the natural jewel.

3. The natural jewelry authenticity identification method according to claim 1, wherein the automatic comparison identification means comprises the following steps:
step A: scanning a natural jewel to be identified to obtain its appearance characteristic data, generating a three-dimensional entity image according to the obtained appearance characteristic data, and further generating a digest code according to information about the three-dimensional entity image; and
step B: comparing the generated digest code with a digest code in archive information about a natural jewel to be identified published by a shipper,
wherein when the comparison is matched, the natural jewel is identified as authentic.

4. The natural jewelry authenticity identification method according to claim 3, wherein the three-dimensional entity image of the natural jewel is generated by using a digital image stitching technique according to the appearance characteristic data obtained by a three-dimensional microscopic scanning method.

5. The natural jewelry authenticity identification method according to claim 3, wherein the step B further comprises the following step:
restoring the three-dimensional entity image of the natural jewel by utilizing a virtual reality modeling language so as to be reproduced on a computer screen.

6. The natural jewelry authenticity identification method according to claim 3, wherein the digest code is formed by compressing the information about the three-dimensional entity image by using a digest algorithm.

7. The natural jewelry authenticity identification method according to claim 4, wherein the three-dimensional microscopic scanning means comprises the following steps:
step 1, placing a natural jewel to be identified in central area of a rotary disk, which can rotate 360 degrees about its rotary shaft;
step 2, placing two microscopic cameras on the vertical rotary stands, adjusting the initial positions of the cameras on the vertical rotary stands to capture the topmost end of the natural jewel to be identified, and adjusting an imaging included angle between the two microscopic cameras and the natural jewel to be identified by rotating the two vertical rotary stands according to a dimension of the natural jewel to be identified;
step 3, rotating the rotary disk 360 degrees about its rotary shaft at a constant speed, obtaining appearance characteristic data including detail characteristics of the natural jewel to be identified by the two microscopic cameras;
step 4, sliding the two microscopic cameras downwards for a certain position; and
step 5, repeating the steps 3 and 4 alternatively, until all appearance characteristic data, including specific region signatures, of the natural jewel to be identified, are obtained.

8. The natural jewelry authenticity identification method according to claim 1, wherein
the uniqueness archive information generation means of a natural jewel comprises: scanning a natural jewel to be identified to obtain its appearance characteristic data, generating a three-dimensional entity image according to the obtained appearance characteristic data, and publishing the three-dimensional entity image; and
the manual comparison identification means comprises: after a receiver receives the natural jewel to be identified, a characteristic region of the natural jewel to be identified being magnified and compared with a corresponding region of the three-dimensional entity image,
wherein when the comparison is matched, the natural jewel is identified as authentic.

9. A natural jewelry authenticity authentication system based on a microscopic three-dimensional imaging technique, comprising:
a uniqueness archive information generation means of a natural jewel; and
an automatic comparison identification means or a manual comparison identification means.

10. The natural jewelry authenticity authentication system according to claim 9, wherein the uniqueness archive information generation system of a natural jewel comprises:
a scanning apparatus configured to scan the natural jewel to obtain the appearance characteristic data thereof;
an image generation module configured to generate a three-dimensional entity image according to the obtained appearance characteristic data; and
an encoding module configured to generate a digest code according to information about the three-dimensional entity image.

11. The natural jewelry authenticity authentication system according to claim 9, wherein the automatic comparison identification means comprises:
a scanning apparatus configured to scan a natural jewel to be identified to obtain an appearance characteristic data thereof;
an image generation module configured to generate a three-dimensional entity image according to the obtained appearance characteristic data;
an encoding module configured to generate a digest code according to information about the three-dimensional entity image; and
a comparison module configured to compare the generated digest code with a digest code in archive information about a natural jewel to be identified published by a shipper;
when the comparison is matched, the natural jewel is identified as authentic.

12. The natural jewelry authenticity authentication system according to claim 11, wherein:
the three-dimensional entity image of the natural jewel is generated by using a digital image stitching technique according to the appearance characteristic data obtained by a three-dimensional microscopic scanning method;
the three-dimensional entity image of the natural jewel is restored by utilizing a virtual reality modeling language so as to be reproduced on a computer screen; and
the digest code is formed by compressing the information about the three-dimensional entity image by using a digest algorithm.

13. The natural jewelry authenticity authentication system according to claim 11, wherein the three-dimensional microscopic scanning method comprises the following steps:
step 1, placing a natural jewel to be identified in a central area of a rotary disk, which can rotate 360 degrees about its rotary shaft;
step 2, placing two microscopic cameras on the vertical rotary stands, adjusting the initial positions of the cameras on the vertical rotary stands to capture a topmost end of the natural jewel to be identified, and adjusting an imaging included angle of the two microscopic cameras and the natural jewel to be identified by rotating the two vertical rotary stands according to a dimension of the natural jewel to be identified;
step 3, rotating the rotary disk 360 degrees about its rotary shaft at a constant speed, obtaining appearance characteristic data including detail characteristics of the natural jewel to be identified by the two microscopic cameras;
step 4, sliding the two microscopic cameras downwards for a certain position; and
step 5, repeating the steps 3 and 4 alternatively, until all of the appearance characteristic data, including specific region signatures, of the natural jewel to be identified, are obtained.

14. A manual comparison identification system of a natural jewel, comprising:
a scanning apparatus configured to scan a natural jewel to be identified to obtain appearance characteristic data thereof,
an image generation module configured to generate a three-dimensional entity image according to the obtained appearance characteristic data, and publish the three-dimensional entity image,
wherein after a receiver receives the natural jewel to be identified, a characteristic region of the natural jewel to be identified is magnified and compared with a corresponding region of the three-dimensional entity image; and when the comparison is matched, the natural jewel is identified as authentic.
